(19) United States
(12) Patent Application Publication
(10) Pub. No.: US 2017/0099988 A1
(43) Pub. Date: Apr. 13, 2017

(54) INTEGRATED OVEN with a TABLET COMPUTER/FLAT PANEL DISPLAY

(71) Applicant: Geniuss Inc., Encino, CA (US)

(72) Inventors: Mehran MATLOUBIAN, Encino, CA (US); Gregg A. HOLLINGSWORTH, Tempe, AZ (US); Timothy J. BROCKETT, Malibu, CA (US)

(21) Appl. No.: 15/289,041

(22) Filed: Oct. 7, 2016

Related U.S. Application Data
(60) Provisional application No. 62/239,506, filed on Oct. 9, 2015.

(51) Int. Cl. A47J 37/06; H05B 6/64; F24C 11/00; F24C 7/00

(52) U.S. Cl. CPC A47J 37/0664; F24C 7/00; H05B 6/6414; F24C 11/00

(57) ABSTRACT

Integration of a tablet computer and/or flat panel display with an oven brings numerous added functionalities to an oven that is not currently possible with current stand alone oven. It creates a new kitchen appliance that can be used for cooking, entertainment, shopping and provides a platform for displaying information and advertisement to the user. Since most kitchens have limited kitchen counter space, integration of the tablet computer/display with an oven can save counter space and provide the ability to watch TV or streaming videos on the oven. This combination can become the central entertainment and communication, as well as control hub in a kitchen for interfacing with other smart appliances as part of Internet of Things (IOTs). This new appliance can be a portal to present information and advertisement to the user with a more user friendly interface for programming the oven, automatically entering cooking instructions, or downloading applications/recipes for using the oven.

### CROSS-REFERENCES TO RELATED APPLICATIONS

This application claims priority to U.S. Provisional Patent Application No. 62/239,506, filed Oct. 9, 2015, entitled “INTEGRATED OVEN with a TABLET COMPUTER/FLAT PANEL DISPLAY” by inventors MEHRAN MATLOUBIAN, et al., commonly assigned and incorporated by reference herein for all purposes.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

The kitchen is one of the main rooms in the house that families tend to gather and spend time together. If there is space available in the kitchen some homes have a TV for entertainment in the kitchen but in most kitchens space (particularly counter space) is limited. More than 99% of the households in the U.S. have at least one type of oven in their kitchens. The ovens are either conventional ovens, or convection ovens, or microwave ovens, or a combination oven (for example a combination of convection oven and microwave oven). The ovens typically have a flat front surface and a window to allow the user to see the food inside of the oven while the food is being heated or cooked. By replacing the window with a flat panel video display/tablet computer and connecting it to a video camera (or cameras) that is pointing into the oven, the food in the oven can be displayed on the video display. The need for having a window to see the food is eliminated but more significantly the addition of the video display provides other added functionalities to the oven. Some of these added functionalities include but not limited to the ability to watch TV or streaming video on the display, use a touch sensitive display for controlling the functions of the oven or programming the oven, including downloading recipes and cooking instructions to be used with the oven.

As mentioned earlier the kitchens also typically have limited counter space, so by having an appliance that can function for both cooking and entertainment one can save kitchen counter space. The new oven-display appliance in addition to being used for cooking and entertainment can be used for shopping as well as a hub to control other internet enabled appliances (Internet of Things, IOTs) within the kitchen or the home.

### BRIEF SUMMARY OF THE INVENTION

Ovens are a common appliance in households throughout the world. They typically have a flat window in the door of the oven to allow the user to see the food while the food is being heated or cooked without having to open the oven door and disrupting the heating/cooking process or allowing heat to escape from the oven. In this invention the window of the oven is replaced by a flat panel touch sensitive video display (or a tablet computer). A video camera is also added pointing at the food inside the oven. This camera can be on the back of the video display (or tablet computer) or on the side walls or top of the oven and in all cases pointing towards the food inside the oven. The video camera is connected to the video display on the oven displaying the food and allowing the user to see the food during heating/cooking and eliminating the need to have the window in the oven door. Eliminating the oven window has other benefits as well. In the case of conventional oven or convection oven eliminating the window reduces the radiated heat from the oven making the oven more efficient. In the case of microwave oven eliminating the window reduces the microwave/RF leakage from the oven reducing interference with WiFi transmissions as well as any health related dangers from exposure to microwave/RF radiation.

In addition to the ability of the user to watch the food during cooking/heating on the video display the video of the food can also be transmitted to a remote device such as the cell phone or computer (or tablet computer) of the user. This will enable the user to monitor the progress of the food and stop or change the settings of the oven remotely or stop the oven when necessary.

To achieve some of the functionalities described above the novel oven-display appliance will have internet connection either through a wire connection such as Ethernet or Powerline or wireless connection through WiFi. Each oven will have a unique IP (Internet Protocol) address. Each oven will also have speakers and can have a microphone, an outward pointing camera, motion sensors, HDMI, USB, and other types of data or video inputs. The user owning one of these ovens can sign up and register their oven online in order to receive software updates for his/her oven or to download recipes or oven programs for cooking specific foods with the oven.

As mentioned above speaker (or speakers) and microphone can also be integrated with the oven. This will allow the oven to be used as a radio or audio streaming device for listening to music, news, weather reports, and traffic updates. The oven can also be used for making over the internet calls through a service such as Skype. Addition of a cell phone transceiver to the oven will enable the oven to be used for making phone calls. The oven can also incorporate technology for understanding voice commands or adding a voice activated personal assistant (such as Alexa from Amazon, Google Now by Google, Cortana by Microsoft, or Siri by Apple). So the user can use voice commands to control the oven, get information from the voice activated personal assistant, or it can be used as a hub to control other appliances that are connected to it. Such applications of this can include but it is not limited to turning lights on/off, setting alarms, giving traffic information, answering questions, reading recipes, adding items to shopping cart or to do list.

Recipes for cooking food or heating food can be stored on the integrated tablet/computer or downloaded via an internet connection to the oven. Applications or programs can be developed by third parties that can be downloaded to the oven. In the case of a tablet computer with an outward looking camera integrated with the oven, the camera can be used for scanning bar codes/QR code on a food package. Based on the scan, the heating parameters (or heating program) can be automatically entered into the oven and instructions for preparing the food for heating is displayed on the video display. In addition, based on the food package scanned, one can show advertisement at the bottom of the display superimposed on the image of the food in the oven. Or one can display other advertisements on a different part of the screen. Advertisements can include, but are not limited to, direct advertisements, internet links to product information, internet links to websites, coupons for discounts, or a button to send information or coupons to an email address, cell phone based application, or physical location through standard mail. The operator of the oven can have the option to add the advertised product to local or internet cloud-based shopping list/cart for purchase or delivery later, or order the product online directly from the oven. The bar code/QR code scanner on the oven can also be used to scan the bar code/QR code of any item (not necessarily a food item) in order to add it to the shopping list or place an order for the item online.

Video, picture, or time lapsed photography of food being heated/cooked in the oven can be shared online or e-mailed to a person's contact. Users can share recipes online with each other.

In addition, the oven can also integrate a proximity sensor that once someone is near the oven display; it fully turns on the display automatically. The display can have a multi-window display in which in one window time and weather are shown and in another window advertisement or coupons are shown, and in a third window various tiles/icons for different functions are displayed. The novel oven-display appliance is a new appliance that in addition to adding new functionalities to the oven for make cooking easier it is also an appliance that can be used for entertainment, shopping, and playing video games.

### BRIEF DESCRIPTION OF THE DRAWINGS

A more complete understanding of the present invention and its advantages will be gained from a consideration of the following description of preferred embodiments, read in conjunction with the accompanying drawings provided herein. In the figures and description, numerals indicate various features of the invention, and like numerals referring to like features throughout both the drawings and the description.

FIG. 1 is a drawing of a typical microwave oven.

FIG. 2 is a drawing of one embodiment of this invention in which a tablet computer/flat panel display replaces the window in the door of the microwave oven.

FIG. 3 is a drawing of the back of the microwave oven of one of the embodiments of this invention showing various connections for video, audio, and data for the microwave oven/tablet computer.

FIG. 4 is a drawing of another embodiment of this invention in which a camera pointing outwards is added on the door frame of the microwave oven.

FIG. 5 is a drawing of another embodiment of this invention in which speakers are added on the door of the microwave oven as well as a microphone on the door frame.

FIG. 6 is a drawing of another embodiment of this invention in which a video camera and an infrared/thermal camera are added pointing into the microwave oven.

FIG. 7 is a drawing of another embodiment of this invention in which the video of the food inside the microwave oven is displayed on the video display and at the bottom of the display a banner advertisement is displayed.

FIG. 8 is a drawing of another embodiment of this invention in which the video of the food inside the microwave oven is displayed as a small window on the video display that is displaying an advertisement on the video screen.

FIG. 9 is a drawing of another embodiment of this invention in which the QR code on a food package is scanned by the camera at top of the video screen of the microwave oven. Based on the QR code the cooking parameters are automatically entered into the microwave oven and the cooking instructions are displayed on the video screen.

FIG. 10 is a drawing of another embodiment of this invention in which the panel portion of a typical microwave oven is integrated as part of the door of the oven and a tablet computer/flat panel display covers substantially the door of the oven.

FIG. 11 is a drawing of another embodiment of this invention in which a tablet computer/flat panel display replaces the window of a counter top convection oven.

### DETAILED DESCRIPTION OF THE INVENTION

The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. While most of the figures are of microwave ovens other types of ovens can be used as well including but not limited to convection ovens, combination convection ovens and microwave ovens, air fryers, combination air fryers and microwave ovens.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object. Additionally, the terms “first” and “second” or other like descriptors do not necessarily imply an order, but should be interpreted using ordinary meaning.

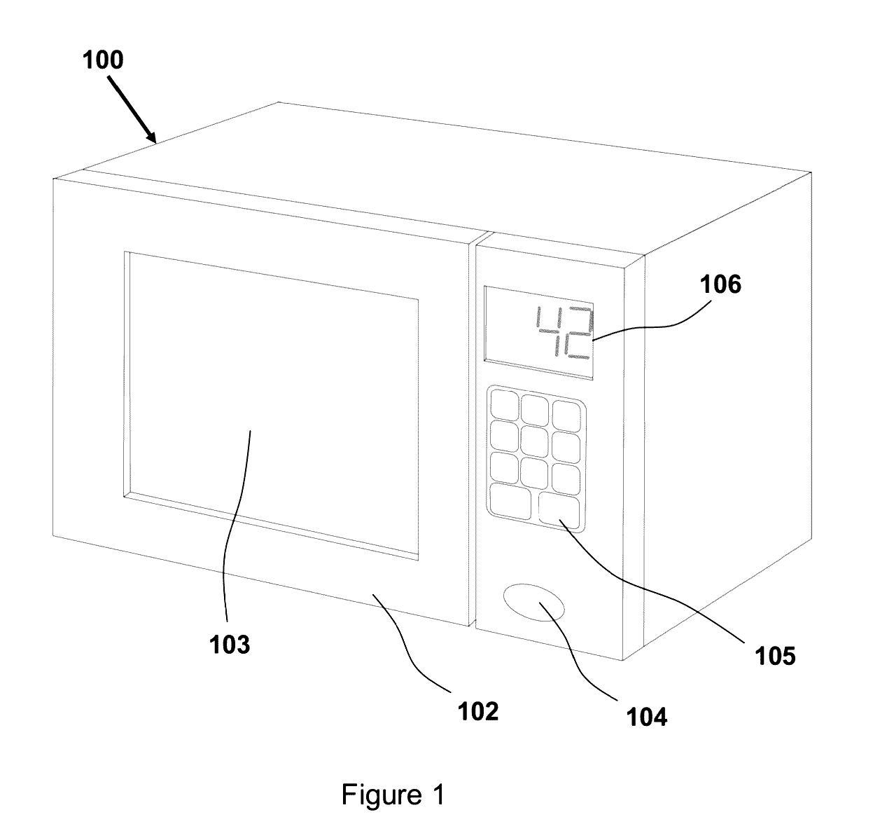

FIG. 1 is a drawing of a typical microwave oven 100. The oven has a control panel 105, and a clock/timer 106. The oven door 102 has window 103 with a mesh screen that allows the user to see the food inside of the oven. The oven door is opened using a push button 104.

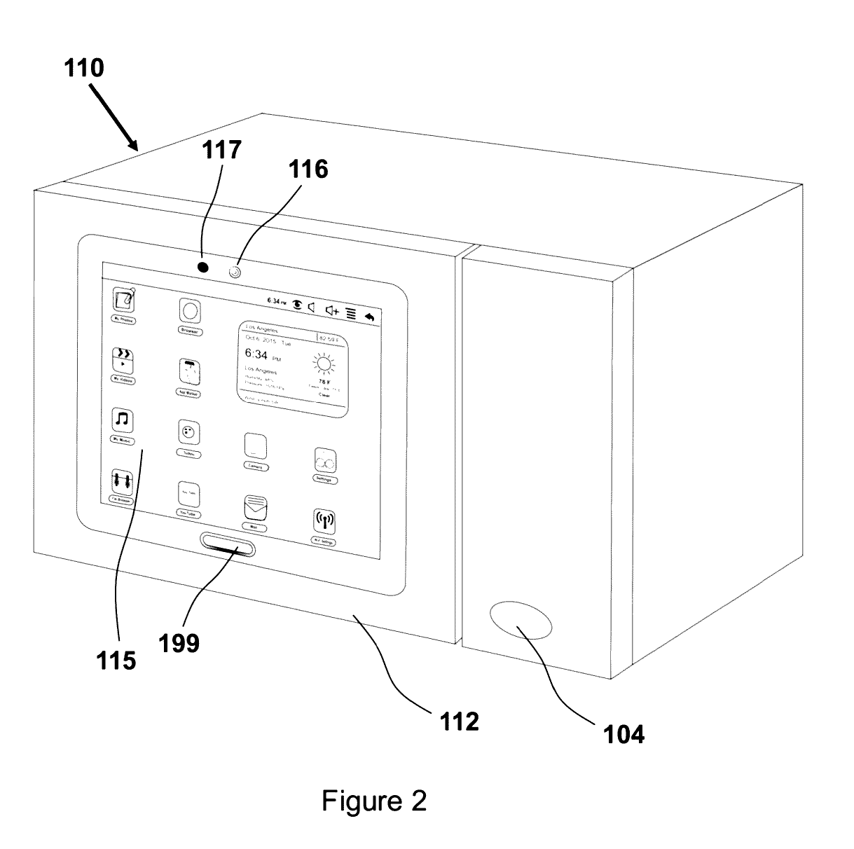

FIG. 2 is a drawing of one embodiment of this invention in which a tablet computer/flat panel display 115 replaces the window in the door 112 of the microwave oven 110 to create a new oven-display appliance. The oven door is opened using a push button 104. The video display has a built in camera 116, a proximity sensor 117, and a Home/reset button 199. The oven also has a camera pointing into the microwave oven (not shown in the drawing) that allows the food in the oven to be displayed on the video screen. This eliminates the need to have a window in the door of the oven to allow the user to see the food while it is being heated or cooked. In addition by adding WiFi transceiver, Bluetooth transceiver, cell phone transceiver, TV tuner, cable tuner, and radio tuner to the microwave oven that it is integrated with a tablet computer/video display it is possible to have many added functionalities. Some of these functionalities include but not limited to the oven-display appliance being used for watching TV or streaming video, listening to music or news, making phone calls or internet calls, adding items to a shopping list and shopping online, surfing the internet or downloading menus or cooking programs to be used with the oven. This novel oven-display appliance can become the center hub in the kitchen and it can be used for cooking, entertainment, shopping, and controlling other appliances as part of IOTs.

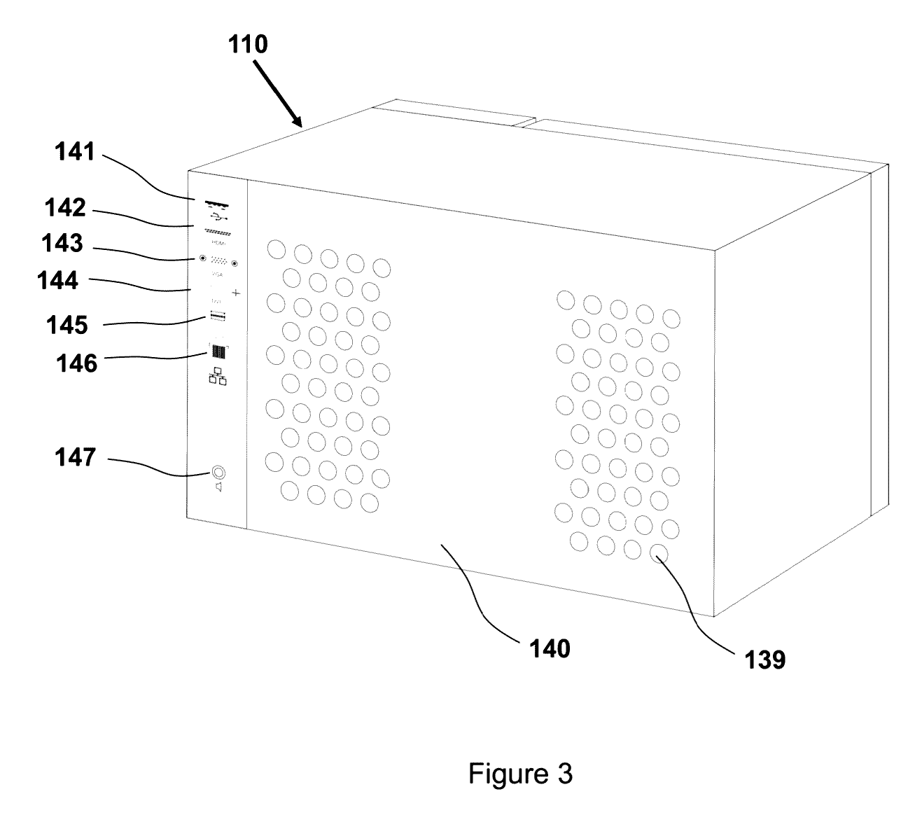

FIG. 3 is a drawing of the back 140 of the microwave oven 110 of one of the embodiments of this invention. In addition to the vent holes 139 in the back of the oven, various connections/ports for video, audio, and data for the microwave oven/tablet computer (oven-display appliance) are shown. The connections/ports include, but not limited to, USB 141, HDMI 142, VGA 143, DVI 144, Mini Display 145, Ethernet 146, and Speaker 147. Many other ports or connections not shown such as USB C and SD card are also possible to include at the back (or in some cases front) of the oven-display appliance.

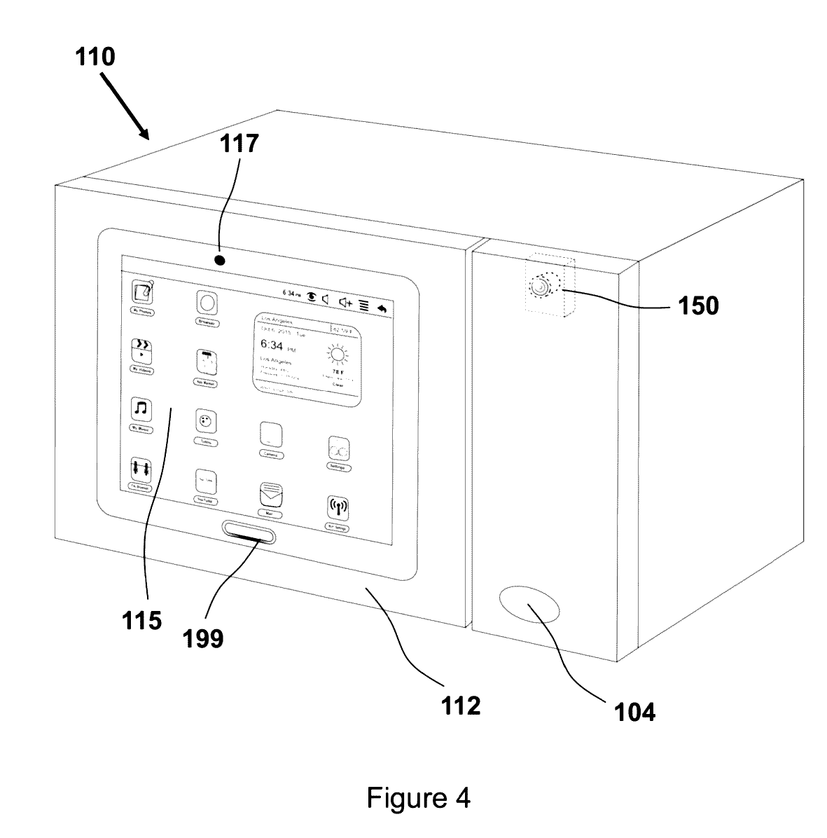

FIG. 4 is a drawing of another embodiment of this invention in which a camera 150 pointing outwards is added on the door frame of the microwave oven 110. Other than the location of the camera, the oven-display appliance has similar functionalities to the oven-display appliance in FIG. 2.

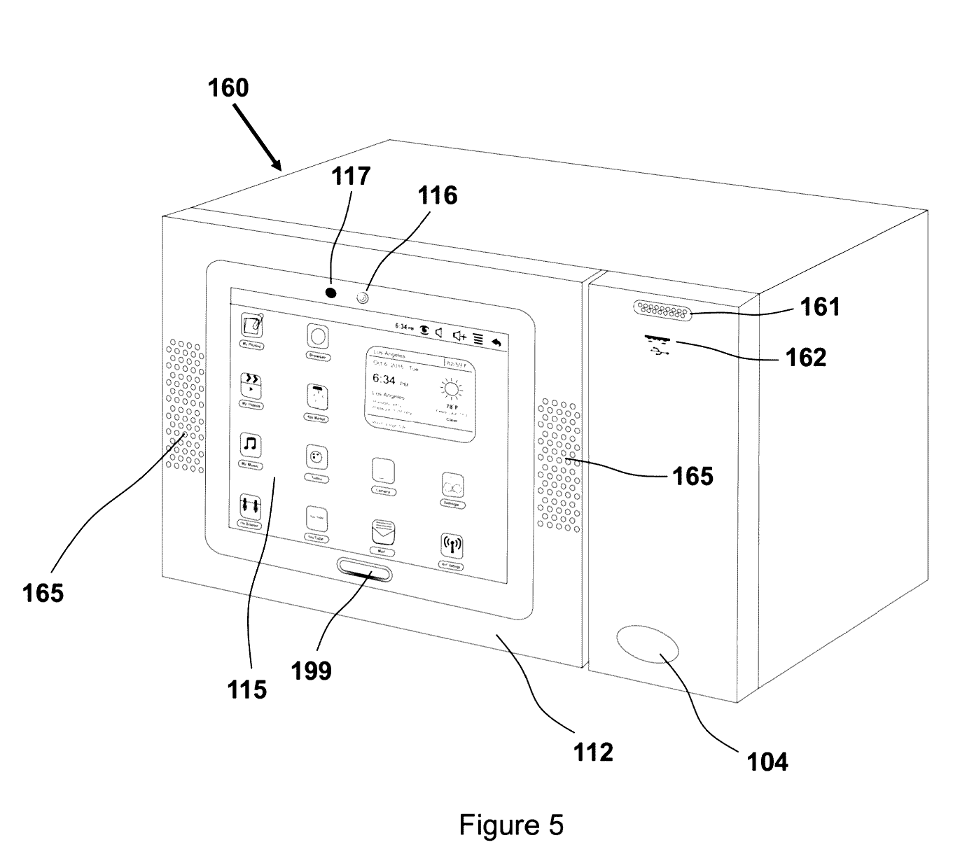

FIG. 5 is a drawing of another embodiment of this invention in which speakers 165 are added on the door 112 of the oven-display appliance 160. In addition a microphone 161 and a USB port 162 are added to the door frame. The speakers can be used to listen to streaming music from the oven-display appliance or listen to news from the integrated radio with the appliance. The speakers can be used in combination with the microphone to make phone calls, internet calls, or video calls. The speakers can also be used for controlling the oven-display appliance by using voice commands or add items to the shopping list. This embodiment also has a camera 116, a proximity sensor 117, a Home/reset button 199, and a camera pointing inward (not shown in drawing) to allow the food to be displayed on the video screen 115 while it is being heated or cooked.

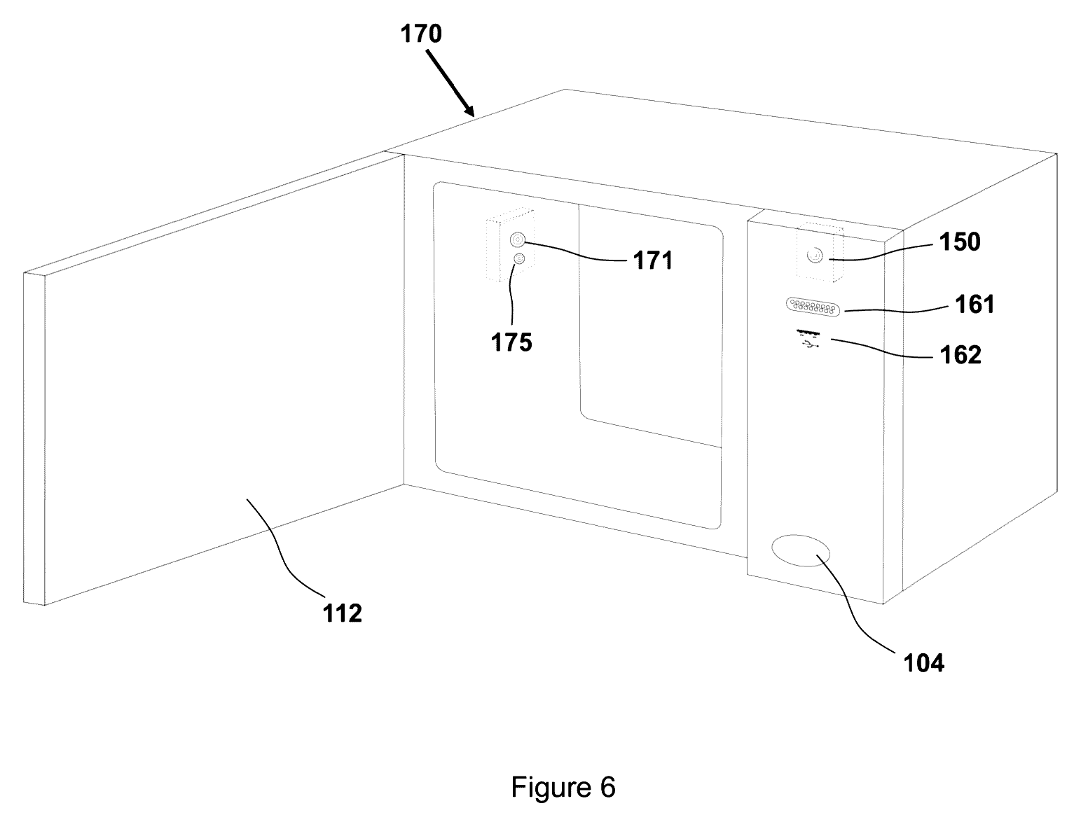

FIG. 6 is a drawing of another embodiment of this invention in which a video camera 171 and an infrared/thermal camera 175 are added pointing into the oven-display appliance 170. The video camera is used to display the food while it is being heated or cooked on the video display (not shown in the drawing) on the door of the oven-display 112. The infrared/thermal camera can measure and display the temperature profile of the food and can be used to determine when the food is ready once the food reaches a pre-set temperature or temperature profile. The oven-display also has a video camera 150 pointing outward as well as a microphone 161 and a USB port 162.

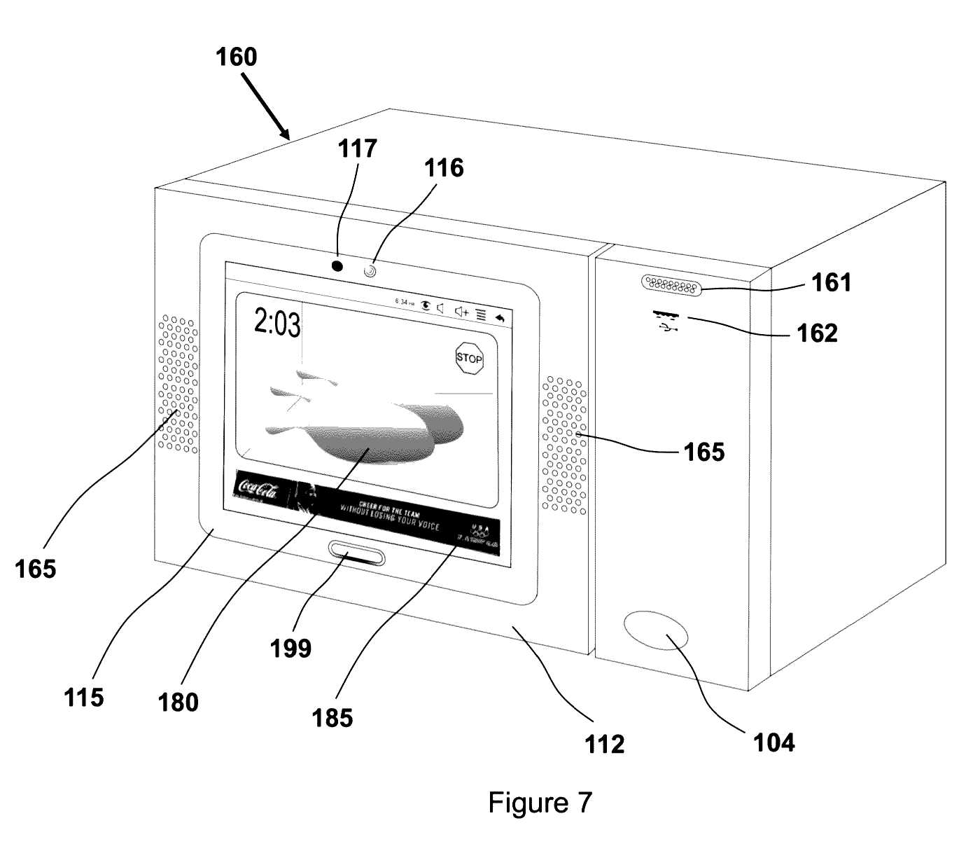

FIG. 7 is a drawing of another embodiment of this invention in which the video of the food 180 inside the microwave oven-display appliance 160 is displayed on the video display 115 and at the bottom of the display a banner advertisement 185 is displayed. This banner advertisement can be based on a number of different parameters including, but not limited to, the shopping or eating habits of the user, location of the user, on the food being heated or cooked in the oven or products that compliment it. Instead of banner advertisement coupons or discounts on products can be presented to the user as well. The oven-display appliance similar to the one in FIG. 5 has speakers 165, microphone 161, USB port 162, video camera 116, and proximity sensor 117.

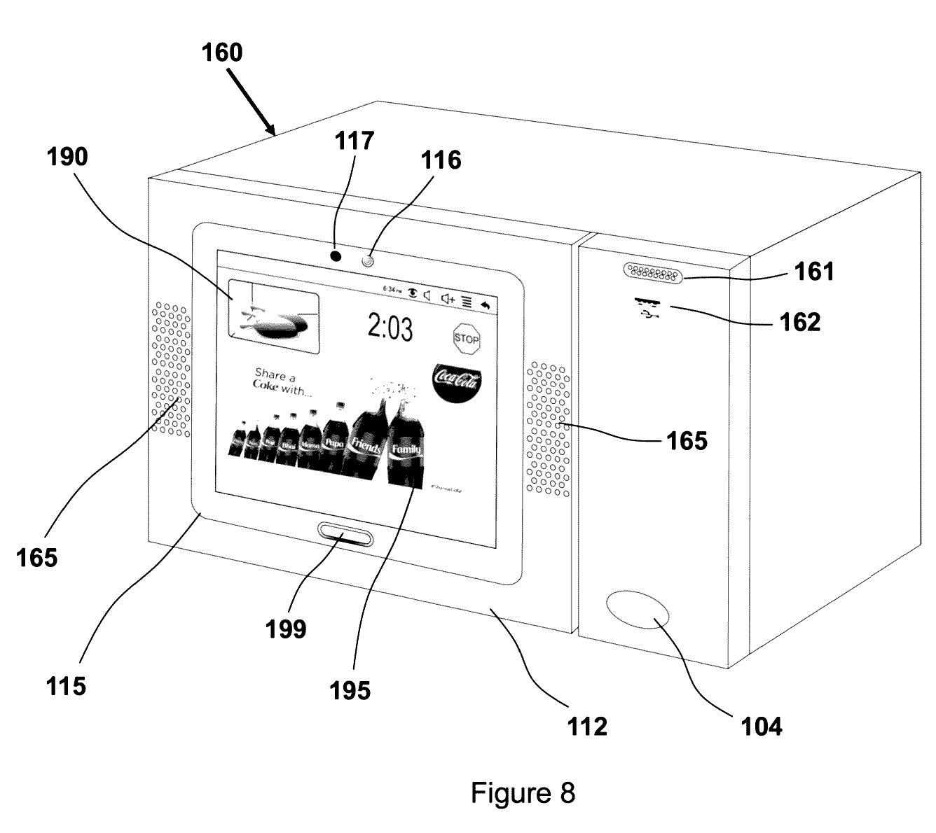

FIG. 8 is a drawing of another embodiment of this invention in which the video of the food 190 inside of the oven-display appliance 160 is displayed as a small window on the video display that is displaying a larger advertisement 195 on the video screen 115. Instead of the advertisement the video screen can also display streaming video to entertain the user while the user is waiting by the oven to heat or cook his/her food. The user will have the ability to select what type of videos to see or based on the users viewing habits videos can be selected automatically for the user to watch.

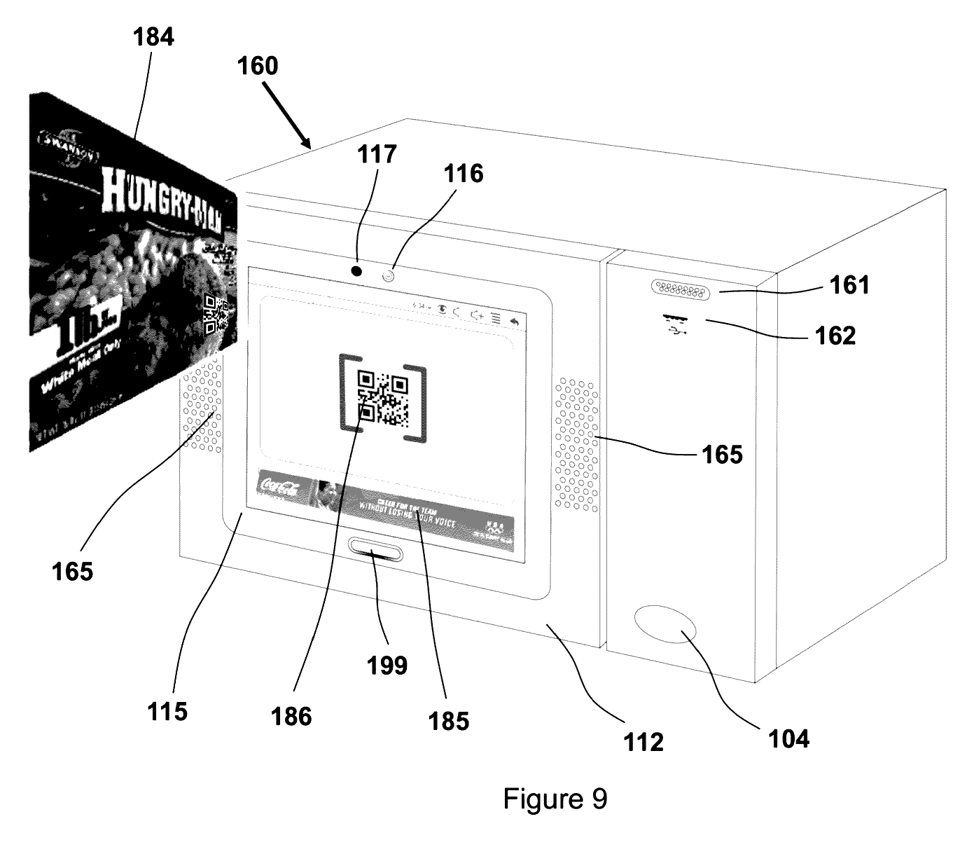

FIG. 9 is a drawing of another embodiment of this invention in which the QR code 186 on a food package 184 is scanned by the camera 116 at top of the video screen of the microwave oven-display appliance 160. Based on the QR code the cooking parameters are automatically entered into the microwave oven and the cooking instructions are displayed on the video screen 115 that is integrated as part of the door 112 of the oven replacing the window of the oven. In addition after the QR code is scanned a banner advertisement 185 is displayed at the bottom of the video screen. This banner advertisement can be based on the food that is going to be heated in the oven or a number of different parameters including but not limited to the shopping or eating habits of the user, or location of the user.

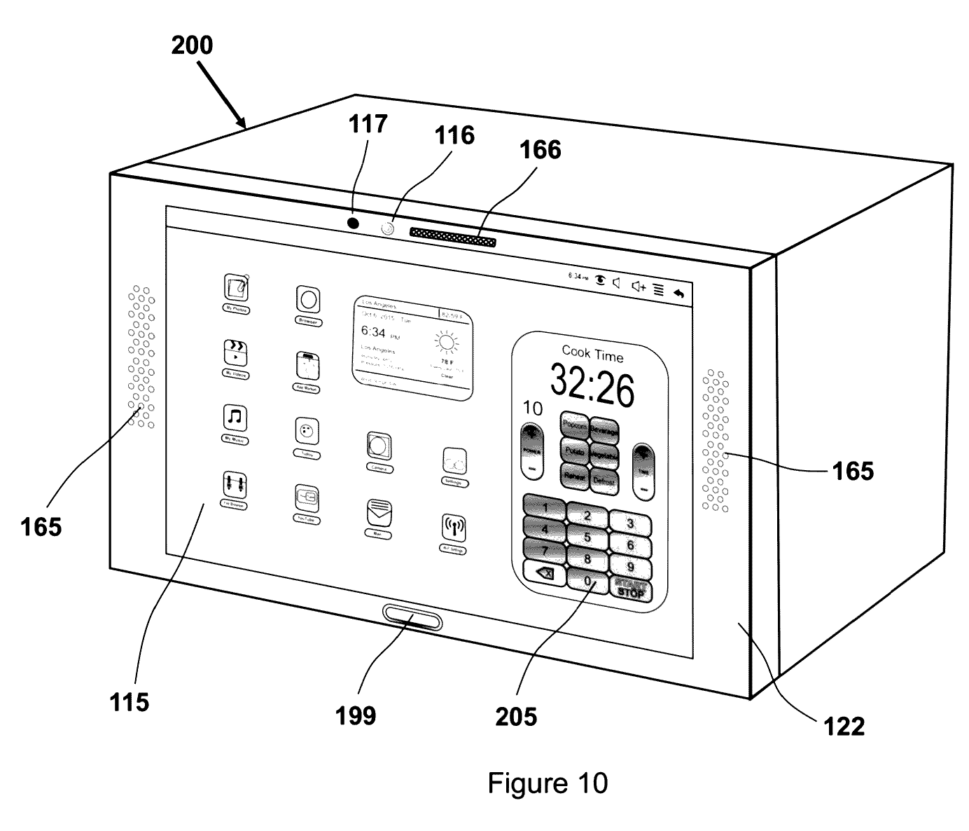

FIG. 10 is a drawing of another embodiment of this invention in which the panel portion of a typical microwave oven is integrated as part of the door 122 of the oven and a tablet computer/flat panel display 115 covers substantially the door of the oven to create a novel oven-display appliance 200. The display is touch sensitive and can display control buttons 205 for controlling the oven. The oven can be programmed using this interface or alternatively pre-programmed routines for heating/cooking food is already included in the oven or cooking programs can be downloaded to the oven via WiFi connection or wired connection to the internet. The oven door can be opened by pushing a touch sensitive icon/button on the screen of the video display. The oven-display appliance also has speakers 165, microphone 166, video camera pointing outward 116, video camera pointing inward (not shown), proximity sensor 117, and a Home/reset button 199. The display can show streaming videos, TV, or can be used to surf the internet.

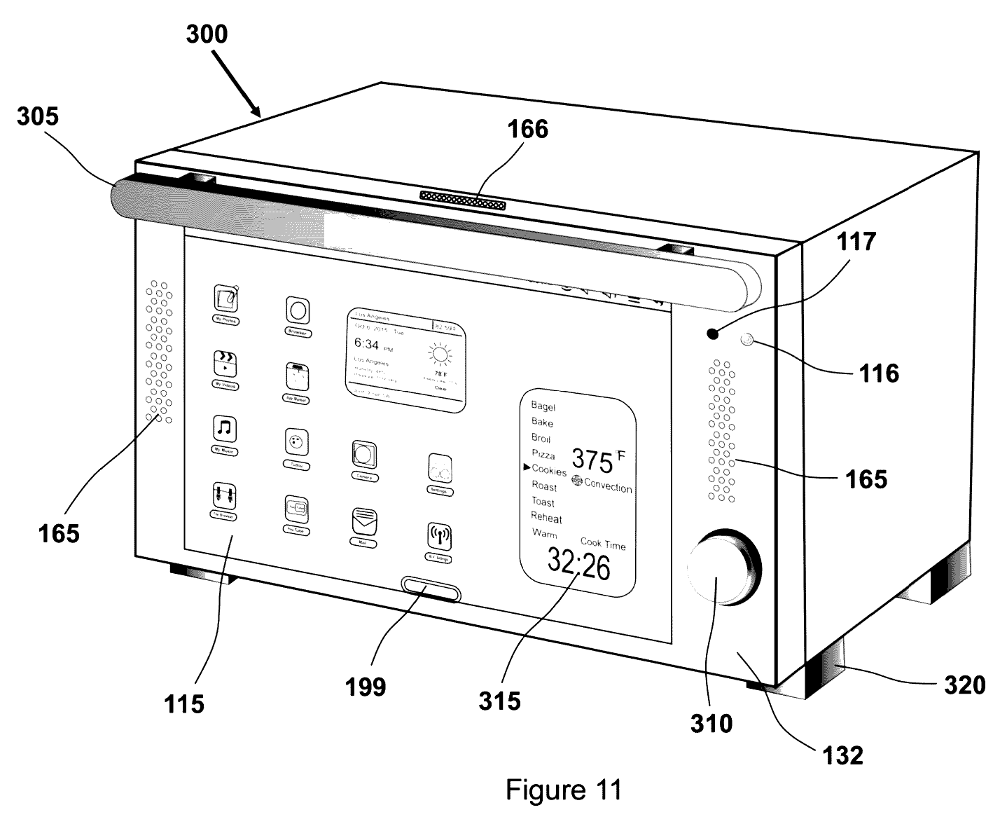

FIG. 11 is a drawing of another embodiment of this invention in which a tablet computer/flat panel display 115 replaces the window in the door 132 of a counter top convection oven to form a novel oven-display appliance 300. The oven has a knob 310 that can be used to adjust some of the parameters of the oven such as cooking time or cooking temperature in conjunction with the touch sensitive video display 315 showing other controls or programs for cooking with the oven. The oven-display appliance also has speakers 165, microphone 166, outward pointing video camera 116, proximity sensor 117, Home/reset button 199, door handle 305, and feet 320. The oven also has an inward pointing camera (not shown in the drawing) that can display the food on the video screen during heating or cooking. By eliminating the window in a typical convection oven the oven becomes more efficient as radiated heat will not escape through the window. The oven also has integrated WiFi transceivers so the video of the food inside can be transmitted to the user's phone for remote monitoring. In addition the oven can have other functionalities similar to the ovens shown in other embodiments.

What is claimed is:

1. An oven integrated with a tablet computer or a flat video display such that the video display or tablet computer covers at least partially or substantially the door of the oven or is integrated as part of the door of the oven.

2. The oven of claim 1 wherein the tablet computer or flat video display replaces substantially the window of the oven.

3. The oven of claim 1 wherein the display is a touch sensitive display.

4. The oven of claim 1 wherein the display is an LCD, OLED, Quantum Dot, or another type of flat panel display.

5. The oven of claim 1 wherein the oven has built-in speakers and microphone.

6. The oven of claim 1 wherein the oven is a convection oven or a microwave oven or a toaster oven, or a combination of two or more types of ovens.

7. The oven of claim 1 wherein the oven is a combination of one or more types of cooking apparatuses.

8. The oven of claim 1 wherein the oven has a combination of one or more wireless and wired transceivers and receivers including WiFi, cellular, Bluetooth, Ethernet, powerline, and GPS.

9. The oven of claim 1 wherein EMI shielding is used to prevent interference by the oven to the electronics and wireless transceivers.

10. The oven of claim 1 wherein the oven has a combination of one or more of TV tuner, cable tuner, radio tuner, RF ID scanner, near field communication (NFC) chip, and Zigbee chip.

11. The oven of claim 1 wherein the oven has any combination of standard audio, video, and computer network and connectivity ports such as, but not limited to, HDMI, Ethernet, AV, Zigbee, USB or similar ports.

12. The oven of claim 1 wherein the oven has built in video and IR camera or cameras for taking pictures or video of what is inside the oven and displaying on the video display or streaming it to other devices including, but not limited to, cell phones, computers, or tablets.

13. The oven of claim 1 wherein the oven can be used to make video calls or audio calls via an internet connection or cellular network.

14. The oven of claim 1 wherein the oven can be used as the kitchen hub.

15. The oven of claim 1 wherein the oven can be used to do shopping via internet, WiFi, or telephone.

16. The oven of claim 1 wherein the oven is used for entertainment including but not limited to watching TV, streaming video, listening to music, listening to radio, or playing video games.

17. The oven of claim 1 wherein the oven's display is used for displaying advertising.

18. The oven of claim 1 wherein the advertisements are linked directly from third-party entities, such as, but not limited to, Google Ads, Amazon.com, Yahoo Ads, or other similar sources.

19. The oven of claim 1 wherein a built-in proximity sensor in the oven is used to turn the video display partially or fully on when a person is detected.

20. The oven of claim 1 wherein the oven is used for shopping.

21. The oven of claim 1 wherein the videos displayed on the oven's video screen is based on the user's preference.

22. The oven of claim 1 wherein the display is used to control or operate the oven.

23. The oven of claim 1 wherein the oven can be controlled by voice command using the built in microphone.

24. The oven of claim 1 wherein the oven can be controlled remotely by a cell phone or a computer.

25. The oven of claim 1 wherein the oven is connected to the internet and can be used to send e-mails, text messages and post photos and videos online.

26. An oven in which the window in the door of the oven has been replaced by a touch sensitive flat panel video display and has wireless transceiver, camera, speakers, and microphone integrated with the oven.

27. The oven of claim 26 wherein the oven is a convection oven or a microwave oven or a toaster oven, or a combination of two or more types of ovens.

28. The oven of claim 26 wherein the oven is used for displaying advertising.

29. The oven of claim 26 wherein the oven is used for shopping or entertainment.

30. The oven of claim 26 wherein the videos displayed on the oven's video screen is based on the user's preference.
